(19) United States
(12) Patent Application Publication
(10) Pub. No.: US 2014/0372666 A1
(43) Pub. Date: Dec. 18, 2014

(54) SEMICONDUCTOR DEVICE WITH CONFIGURABLE SUPPORT FOR MULTIPLE COMMAND SPECIFICATIONS, AND METHOD REGARDING THE SAME

(71) Applicant: PS4 Luxco S.a.r.l., Luxembourg (LU)

(72) Inventors: Giuseppe MOIOLI, Albino (BG) (IT); Luca BATTU, Paderno D' Adda (LC) (IT); Stefano SURICO, Bussero (MI) (IT)

(21) Appl. No.: 13/918,596

(22) Filed: Jun. 14, 2013

(51) Int. Cl. G06F 12/02

(52) U.S. Cl. CPC G06F 12/0246
USPC 711/103

(57) ABSTRACT

A device includes a NAND flash memory, and a generic command interface configured to interpret both an Open NAND Flash Interface specification and a first NAND flash specification to perform an associated one of command operations on the NAND flash memory, the Open NAND Flash Interface specification and the first NAND flash specification being different from each other.

### FIELD OF THE DISCLOSURE

The present disclosure relates to a semiconductor device, and particularly, but not exclusively, relates to a semiconductor device with configurable support for multiple types of command sets, and a method of implementing and operating the same, and the following description is made with reference to this field of application for convenience of explanation only.

The present disclosure also relates to any electronic appliances that may be implemented from one or more semiconductor devices with configurable interfaces or support in accordance with the following descriptions.

### BACKGROUND OF THE DISCLOSURE

Recently, non-volatile memory is incorporated in various kinds of consumer electronic products. Flash memory chips, especially NAND flash memory chips, are known such as the non-volatile memory and NAND flash memory chips are the most widely used form of non-volatile memory circuits today.

NAND flash memory chips are manufactured by various vendors (i.e. manufacturers). These chips from different vendors use similar packaging, have similar pinouts, and accept similar sets of low-level commands.

However, “similar” configuration is not optimal. There exist differences in timing and command set (e.g., acceptable command sequences).

The Open NAND Flash Interface (ONFI) Working Group, which is a consortium of technology companies, was created in 2006 in order to standardize the specifications in NAND flash memory chips.

However, the effort was not hugely successfully, and many vendors in the NAND flash market still do not follow the specifications announced by the ONFI Working Group. In fact, the world's largest manufacturers of NAND flash chips are not members of the ONFI consortium.

Accordingly, some NAND flash memories in the current market have the ONFI specifications while other NAND flash memories have different specifications, including, but not limited to, the “de facto” market standard specifications.

The existence of these multiple different protocols and specifications for NAND flash memory chips governing, for example, the command set and timing, used to perform similar operations on the NAND flash memory chip makes it difficult to build NAND-based products.

### SUMMARY

According to the embodiment of the present disclosure, there may be provided a device including a NAND flash memory, and a generic command interface configured to interpret both an Open NAND Flash Interface specification and a first NAND flash specification to perform an associated one of command operations on the NAND flash memory, the Open NAND Flash Interface specification and the first NAND flash specification being different from each other.

According to another embodiment of the present disclosure, there may also be provided a method including providing a device comprising a command terminal and a command interface that supports multiple command specifications including an Open NAND Flash Interface specification and a first specification that is different from the Open NAND Flash Interface specification, receiving a command signal from the command terminal of the device, selecting one of the multiple command specifications to be interpreted, and interpreting the command signal in response to the receiving of the command signal and the selecting of the one of the multiple command specifications so that a remaining of the multiple command specifications is free from being interpreted.

### BRIEF DESCRIPTION OF THE DRAWINGS

FIG. 1 schematically illustrates a block diagram of a semiconductor device, particularly a NAND memory device, to which any one or more embodiments of the present disclosure may apply.

FIG. 2 schematically shows an example of a basic operation command set for a NAND flash memory that may be used for the device 100 in FIG. 1.

FIG. 3 shows an example of a page-read operation command set for a NAND flash memory, according to the format shown in FIG. 2.

FIG. 4 shows an example of a page-program or page-write operation command set for a NAND flash memory, according to the format shown in FIG. 2.

FIG. 5 shows an example of a configurable interface that can support multiple specifications, according to a first embodiment of the present disclosure.

FIG. 6 shows an example of a configurable interface that can support multiple specifications, according to a second embodiment of the present disclosure.

FIG. 7 shows an example of a configurable interface that can support multiple specifications, according to a third embodiment of the present disclosure.

FIG. 8 shows an example of a configurable interface that can support multiple specifications, utilizing a correspondence table, which may apply to the interface 702 in FIG. 7.

FIG. 9 shows an example of a configurable interface that can support multiple specifications, according to a fourth embodiment of the present disclosure.

FIG. 10 shows one or more examples of a system where a NAND memory device with a configurable interface may be utilized, according to a fifth embodiment of the present disclosure.

### DETAILED DESCRIPTION OF THE EMBODIMENTS

One of representative examples of a technological concept of the present disclosure which seeks to solve, at least, the problems mentioned above will be described below. The claimed contents of the present application are not limited to the technological concept described below but are also described in the claims of the present application.

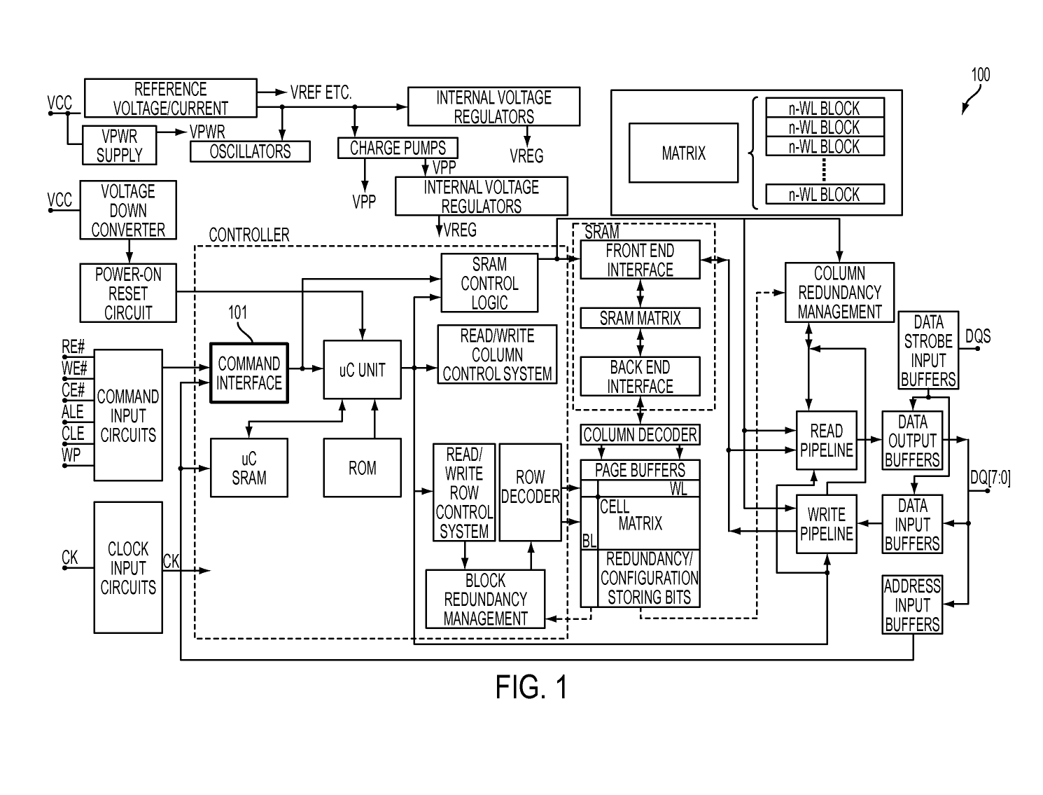

The present disclosure makes reference to non-volatile memory, especially a NAND memory device, usually including one or more memory arrays, together with the dedicated circuitries, an example of which is shown in FIG. 1.

According to embodiments of the present disclosure, there is provided a semiconductor device with a configurable interface that can support multiple different specifications, especially multiple different NAND specifications.

The semiconductor device, according to the present disclosure, may be compatible to multiple different specifications

The semiconductor device, according to the present disclosure, may allow faster and easier development of NAND-based product, and consequently, a reduced price for such product, as well as increased competition among manufacturers of the NAND-based product.

FIG. 1 schematically illustrates a block diagram of a semiconductor device, particularly a NAND memory device, to which any one or more embodiments of the present disclosure may apply.

The semiconductor device 100 includes a controller and a non-volatile memory, among other things that are exemplarily shown in FIG. 1. For example, the device 100 may also include a volatile memory (e.g., a static random-access memory, SRAM), reference voltage generator circuits and various input/output decoders.

The device 100 is configured to receive various command signals, such as RE#, WE#, CE#, ALE, CLE, WP, via command input circuits. These command signals are then inputted to command interface 101 and then to the microcontroller unit.

The command interface 101 may be configured to latch command signals inputted from the command input circuits and then generate corresponding internal signals to be processed by the microcontroller unit. In conjunction with these command signals that are inputted from the command input circuits, one or more clock signals are also inputted from the clock input circuits. The inputted clock signal(s) may be used by the controller of the device 100, for example, as a reference to the timing instructions embedded in the command signals.

Currently, as explained above, there are multiple different types of specifications that may be used in a NAND flash memory. For example, there are “de facto” market standard specifications (hereinafter, “standard specifications”) and the specifications set by the ONFI consortium (hereinafter, “ONFI specifications”).

Such differences in NAND flash memory chips may include, for example, the command set, timing, pinouts, etc.

In order to solve, at least, the problems identified above, the semiconductor device 100 is configured to support, at least, the two types of NAND specifications—standard specifications and ONFI specifications—by use of a configurable command interface 101.

The configurable command interface 101 may be configured to support multiple specifications at the manufacturing step such that a designer and/or a user of the device 100 with the configurable command interface 101 may configure the device 100 later to select which specifications should be used and/or fixed for the device 100.

This may provide increased flexibility to designers and manufacturers of NAND-based products.

For example, the configurable command interface 101 may be manufactured in a configurable state at the wafer sort step, and a user may configure the interface 101 later by programming a dedicated non-volatile memory register, such as content addressable memory (CAM).

The device 100 in FIG. 1 may be a 32 nm CT-NAND (charge-trap NAND) memory that is able to support two different standards currently existing in the market, i.e., single-level cell (SLC) and multi-level cell (MLC). The following description will be based on this 32 nm CT-NAND memory with configurable interface to support SLC/MLC standards for convenience of explanation only, and the device 100 may be implemented on a different type and/or size of a NAND memory, including, but not limited to, 19 nm NAND, 24 nm NAND, and 50 nm NAND, applying the same concept and spirit of idea disclosed herein, as well as making obvious modifications to tailor it to specific needs and conditions.

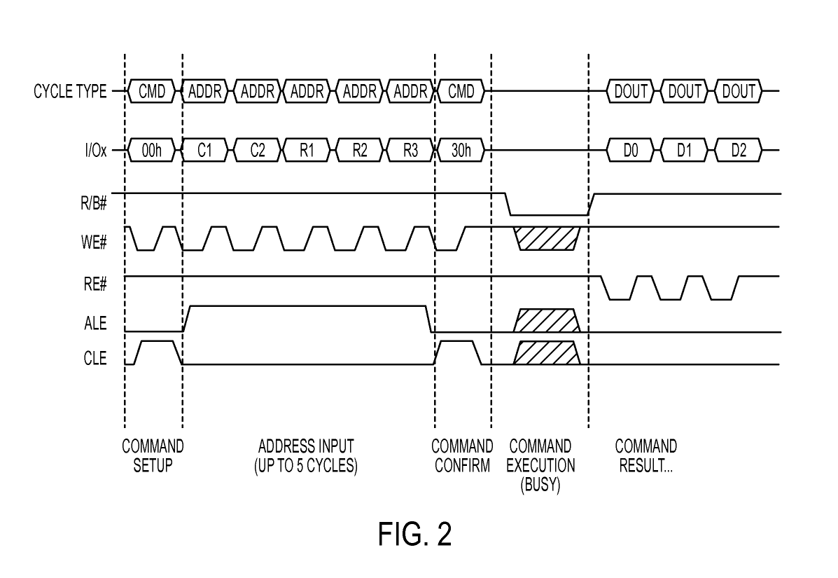

FIG. 2 schematically shows an example of a basic operation command set for a NAND flash memory that may be used for the device 100 in FIG. 1.

FIG. 2 shows an example of the format of an operational command in a NAND flash memory, including control signals such as R/B#, WE#, RE#, ALE and CLE, and their corresponding cycle types and input/outputs (I/Ox).

Typically, a command may be composed of four sections: the first section indicating a command setup code, which may be 1-byte wide; the second section indicating one or more address cycles that are used to address the targeted part of the NAND matrix in the device; the third section indicating one or more data cycles, when the commanded operation is a data-input for the NAND matrix; and the fourth section indicating a command confirmation code, which may be 1-byte wide.

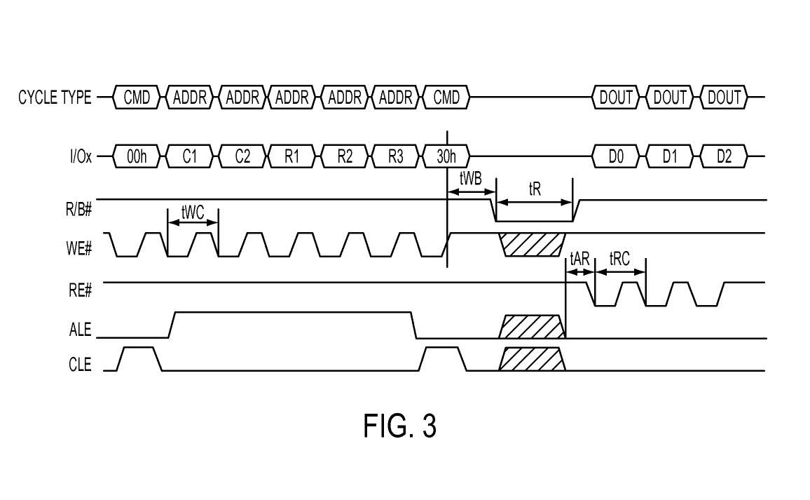

FIG. 3 shows an example of a page-read operation command set for a NAND flash memory, according to the format shown in FIG. 2.

CMD cycle indicates the start of a command. ADDR cycles indicate the address of the target cell or cells in the NAND matrix for the page-read operation. The target page address includes column address (C1˜C2) and row address (R1˜R3). The column and row address bytes may be configured such that C1-byte represents the least significant information in the column address, and R1-byte represents the least significant information in the row address. Dout cycles indicate the data that have been read from the target page. For example, D0, D1, D2 . . . Dn in the Dout cycles represent the data bytes that have been read from the addressed page.

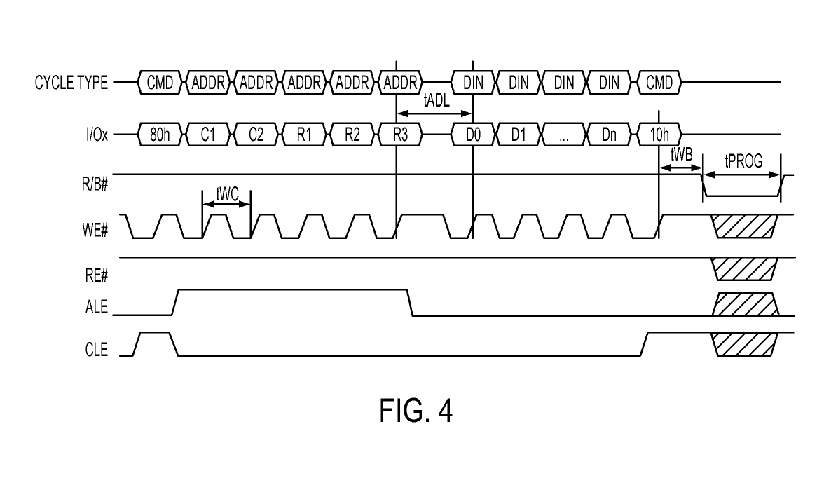

FIG. 4 shows an example of a page-program or page-write operation command set for a NAND flash memory, according to the format shown in FIG. 2.

CMD cycle indicates a start and end of a command. ADDR cycles indicate the address of the target cell or cells in the NAND matrix for the page-program or page-write operation. The target page address includes a column address (C1˜C2), indicating the column address of the starting buffer location to program the data into, and a row address (R1˜R3), indicating the row address of the page being written in.

The column and row address bytes may be configured such that C1-byte represents the least significant information in the column address, and R1-byte represents the least significant information in the row address.

Din cycles indicate the data that are to be programmed or written into the target page addressed by the column and row addresses. For example, D0, D1, D2 . . . Dn in the Din cycles represent the actual data bytes that are to be programmed or written into the addressed page.

The command interface 101 of the device 100 in FIG. 1 may be designed in order to accept a wide range of commands, according to multiple different NAND specifications, including, but not limited to, all of the following commands: reset; page read; page program/write; block erase; cache operations including cache-read and cache-program/write; multiplane operations including multiplane-read, multiplane-program, multiplane-erase; read-status register; and read ID.

For example, the command interface supporting multiple different NAND specifications should be able to recognize the correct or incorrect sequence of command inputs, such as a CMD/ADDR/DATA input sequence, according to the multiple different standards. Based on the recognition, the command interface should be able to abort a sequence that has been recognized as an incorrect subsequence but execute a sequence that has been recognized as a correct sequence. Execution of a sequence as used herein indicates the execution of an operation requested in the command sequence.

Here, the command inputs may be inputted from the NAND command input circuits, and may be recognized by the command interface 101, as shown in FIG. 1.

As previously noted, NAND vendors design their NAND interfaces without reference to any international standard and, consequently, the same or similar operations and/or functions may be achieved on these NAND interfaces with different command sequences, e.g., CMD/ADDR/DATA input sequences. Further as previously noted, the ONFI specifications exist, but are often not followed by the NAND flash market participants. In fact, the market has a de facto standard, which is different from the ONFI standard.

Table 1 below shows an example of the differences between the market's de facto standard and ONFI standard.

TABLE 1
Example of differences between the ONFI and de facto
standard specifications for NAND device commands.

| | | | 2^{nd} | 3^{rd} | 4^{th} |
|---|---|---|---|---|---|
| Command | | 1^{st} Cycle | Cycle | Cycle | Cycle |
| Multiplane Page | Standard | 80 h | 11 h | 81 h | 10 h |
| Program/Write | ONFI | | | 80 h | |
| Multiplane | Standard | 85 h | 11 h | 81 h | 10 h |
| Copyback Program | ONFI | | | 85 h | |
| Multiplane Block | Standard | 60 h | 60 h | D0 h | — |
| Erase | ONFI | | D1 h | 60 h | D0 h |
| Cache Read | Standard | N.A. | | | |
| (Random) | ONFI | 00 h | 31 h | — | — |
| Read-Status | Standard | F1 h/F2 h/ . . . | — | — | — |
| Enhanced | ONFI | 78 h | — | — | — |
| Read Parameter | Standard | N.A. | | | |
| Page | ONFI | ECh | — | — | — |

For example, the configurable command interface 101 may support both the de facto standard and ONFI standard specifications of NAND device commands. Further details regarding the implementation of such a configurable command interface will be explained below, with reference to exemplary embodiments.

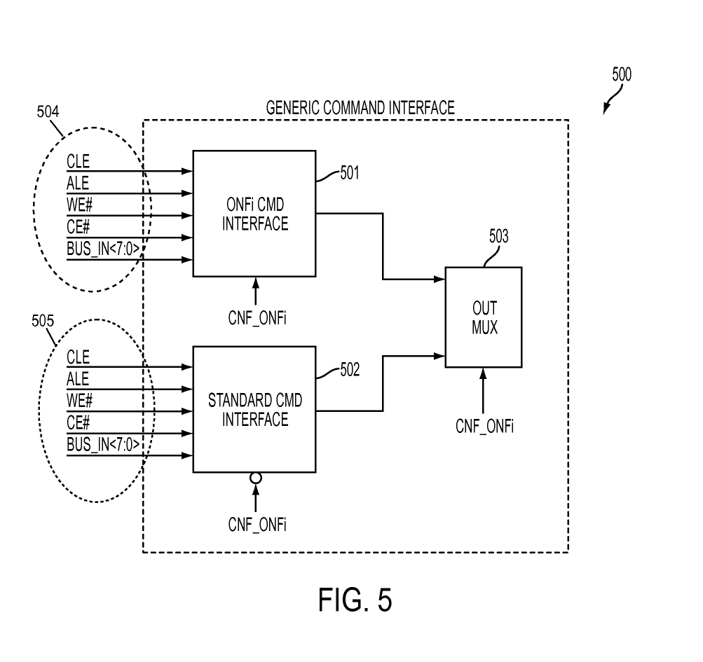

FIG. 5 shows an example of a configurable interface that can support multiple specifications, according to a first embodiment of the present disclosure.

According to this first embodiment of the present disclosure, there may be provided a device including a NAND flash memory, and a generic command interface. The generic command interface may include a first command interface configured to interpret the Open NAND Flash Interface specification, a second command interface configured to interpret the first NAND flash specification, and a selection terminal supplying a selection signal to select one of the first and second interfaces, the selected one of the first and second interfaces interpreting a command signal so that an non-selected one of the first and second interfaces are free from interpreting the command signal.

The interface 500 shown in FIG. 5 includes two separate interfaces, the ONFI CMD interface 501 and the standard CMD interface 502, which are both connected to a multiplexer 503. Each interface is separate in that each interface separately takes the command set, including CLE, ALE, WE#, CE#, BUS_IN<7:0>.

The ONFI CMD interface 501 is configured to interpret an Open NAND Flash Interface (ONFi) specification.

The disclosures are incorporated herein in their entirety by referring to the documents disclosed at the website of ONFi work group (http://www.onfi.org/)

The standard CMD interface 502 is configured to interpret a specification that is different from the ONFi specification.

The specification may include, for example, specifications of flash memory (standard NAND), Solid State Drives, eMMC (Embedded Multi Media Card), or Universal Flash Storage (UFS) defined by JEDEC (Solid State Technology Association, or Joint Electron Device Engineering Council).

The disclosures are incorporated herein in their entirety by referring to the documents disclosed at the website of JEDEC (http://www.jedec.org/category/technology-focus-area/flash-memory-ssds-ufs-emmc)

The specification may also include, for example, a flash memory specification used in USB (Universal Serial Bus) drive or SD (Secure Digital) card.

The disclosures are incorporated herein in their entirety by referring to the documents disclosed at the website of SD association (http://www.usb.org/home)

The disclosures are incorporated herein in their entirety by referring to the documents disclosed at the website of SD association (https://www.sdcard.org/home/)

The disclosures are incorporated herein in their entirety by referring to documents disclosed by NVMHCI (Non-Volatile Memory Host Controller Interface) Working Group.

In another example, the interface 500 may be configured to interpret at least two of the specification as mentioned above. The two specifications may be chosen discretionary, and may be chosen based on a product.

In still another example, the interface 500 may be configured to three of the specifications as mentioned above.

The terminals 504 are for ONFi and are connected to the ONFi COM interface 501. ONFi command signals are input to the terminal 504. Thus, an external device or an external controller can order the flash memory device to perform an appropriate operation by using an ONFi specification.

The terminals 505 are for standard and are connected to the standard COM interface 502. Standard command signals are input to the terminal 505. Thus an external device or a external controller can order the flash memory device to perform an appropriate operation by using a standard specification.

The terminals 505 for standard may be identical respectively to the terminals 504 for ONFi.

In another example, the terminals 505 for standard may be provided independently from (non-identical to) the terminals 504 for ONFi, so that the standard CMD interface 502 can receive its own command signals.

One of the two interfaces is selected by a signal, CNF_ONFI. The CNF_ONFI signal may be generated based on data stored in the configuration bit of the matrix, in CAM, fuse, anti-fuse, or in a switch such as a resistor.

After the device has been manufactured by a manufacturer, the configuration for a specification to be selected can be set up and is fixed. In this way, the command specification to be used in the device is not necessary to be decided until the product shipping to a customer or a user (i.e. until the end of manufacturing process). A manufacture can finally decide a specification to be selected and be used for a customer or a user.

According to the CNF_ONFI signal that may be inputted to the ONFI CMD interface 501, standard CMD interface 502, and the multiplexer 503, the appropriate interface is activated and connected to the rest of the circuit via the multiplexer 503.

For example, if the CNF_ONFI signal carries information indicating activation of the ONFI specifications, the ONFI CMD interface 501 is activated to receive and interpret the command set, and the standard CMD interface 502 is deactivated, whereas the multiplexer 503 connects the ONFI CMD interface 501 to the rest of the circuit in the semiconductor device.

The configuration may be done by storing appropriate data according to desired technical specifications in configuration data storage medium, such as in a configuration bit of the matrix, CAM, a switch, a resistor, or any equivalent thereof.

Such configuration may be done by vendors before the semiconductor device is shipped out to users, or may be left for the users to select desired configurations. This provides increased flexibilities in designing electronic products from multiple semiconductor memory devices.

The example shown in FIG. 5 may allow a simple implementation of a configurable interface in a semiconductor device. However, it may not be the most optimal implementation in terms of, for example, the area efficiency because it does not take advantage of the command sets that are shared by, or common to, the two different standards. In other words, for those command sets that are identical between the two different standards, the logic circuits in each of the two interfaces for the two different standards may also be identical and therefore may be shared by the two interfaces, which can consequently save the space needed for each of the logic interfaces.

Accordingly, there is provided a second embodiment of the configurable interface according to the present disclosure where the interface may consider the command sets that are common to multiple different standards supported by the interface.

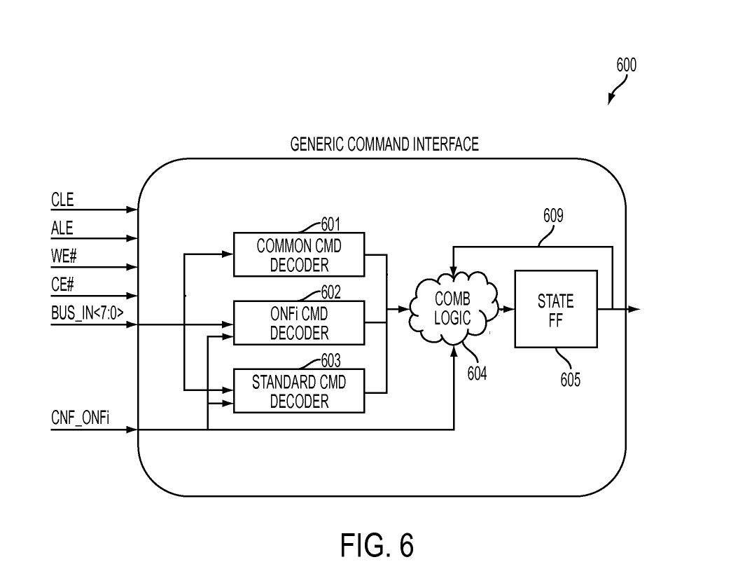

The second embodiment of the configurable interface according to the present disclosure will be explained in further detail below with reference to an example shown in FIG. 6.

FIG. 6 shows an example of a configurable interface that can support multiple specifications, according to a second embodiment of the present disclosure.

According to a second embodiment of the present disclosure, there may be provided a device including a NAND flash memory, and a generic command interface. The generic command may interface include, a first terminal supplied with a first signal, a first interpreter coupled to the first terminal and configured to interpret the Open NAND Flash Interface specification in response to the first signal supplied from the first terminal, a second interpreter coupled to the first terminal and configured to interpret the first NAND Flash specification in response to the first signal supplied from the first terminal, a third interpreter coupled to the first terminal and configured to detect one of the Open NAND Flash Interface specification and the first NAND flash specification that the first signal supplied at the first terminal belongs to, and a selection terminal supplying a selection signal to select one of the first and second command decoders.

As shown in Table 1, there may be three possible situations caused by the differences in the format of the command set according to the ONFI specifications and the same according to the standard specifications.

The first situation occurs where a command is valid only for the ONFI specifications and not for the standard specifications. In this case, the command setup sequence is different for the ONFI specifications and the standard specifications. Examples include a read-status enhanced command in the 1^{st} cycle, which should be 78h for the ONFI specifications but should be F1h, F2h, . . . for the standard specifications.

The second situation occurs where a command setup is partially valid for either the ONFI specifications or the standard specifications. In this case, the command setup sequence for the ONFI specifications may overlap partially with the command setup sequence for the standard specifications. Examples include a multiplane page program/write command, which has the same setup sequence for both the ONFI and standard specifications in the 1^{st} cycle (e.g., first setup) but has different sequence in the 3^{rd} cycle (e.g., second setup)—80h for the ONFI specifications and 81h for the standard specifications, and a multiplane copyback program command, which also has the same setup sequence for both the ONFI and standard specifications in the 1^{st} cycle (e.g., first setup) but has different sequence in the 3^{rd} cycle (e.g., second setup)—85h for the ONFI specifications and 81h for the standard specifications.

The third situation occurs where a command has the same initial setup sequence for the ONFI specifications and the standard specifications but has different sequences for the body of the command. Examples include a multiplane block erase command, which has the same initial setup sequence in the 1^{st} cycle but has different sequences from thereon.

Considering the above three situations, there may be provided a generic common command interface according to a second embodiment of the present disclosure, an example of which is shown in element 600 in FIG. 6. The interface 600 in FIG. 6 includes a common CMD decoder 601, ONFI CMD decoder 602, Standard CMD decoder 603, combinatory logic circuit 604, and state flip-flop 605. The interface 600 receives the command signals such as CLE, ALE, WE#, CE# as well as the BUS_IN<7:0> signal and CNF_ONFI signal. Specifically, the BUS_IN<7:0> signal is applied to each of the decoders, the common CMD decoder 601, the ONFI CMD decoder 602, and the standard CMD decoder 603. The CNF_ONFI signal is applied to each of the ONFI CMD decoder and standard CMD decoder as well as to the combinatory logic circuit 604.

In this example, the CNF_ONFI signal may carry similar information as the CNF_ONFI signal explained with reference to the first embodiment. For example, the CNF_ONFI signal may be used to select one of the ONFI CMD decoder 602 and the standard CMD decoder 603. After the appropriate decoder is selected by the CNF_ONFI signal, the selected decoder decodes the command signals and interprets the requested operation embedded in the command signals.

The common CMD decoder 601 may be configured to decode, based on the inputted command signals (CLE, ALE, WE#, CE#, or equivalent thereof), whether the inputted command has a sequence in accordance with the ONFI specifications or has a sequence in accordance with the standard specifications.

For example, there may be some sequences that are unique to either one of the ONFI specifications or the standard specifications, and other sequences may be shared by the two specifications.

Referring back to Table 1, the sequence 80h, for example, may be used for either the ONFI specifications or the standard specifications and thus is considered a common sequence. Accordingly, when the sequence 80h is recognized by the common CMD decoder 601, the decoder 601 outputs a signal indicating a common sequence to the combinatory logic circuit 604.

On the other hand, the sequence D1h, for example, may be used only for the ONFI specifications. Accordingly, when the sequence D1h is recognized by the common CMD decoder 601, the decoder 601 outputs a signal indicating the ONFI specifications to the combinatory logic circuit 604.

Similarly, the sequence D0h, for example, may be used only for the standard specifications. Accordingly, when the sequence D0h is recognized by the common CMD decoder 601, the decoder 601 outputs a signal indicating the standard specifications to the combinatory logic circuit 604.

An operation of the generic command interface 600 will be explained below with reference to several exemplary situations.

When the first situation defined above occurs—i.e., when a command set that is valid only for one specification is inputted to the interface 600 such as, for example, the sequence F1h for read-status enhanced operation, the common CMD decoder 601 recognizes that the sequence F1h is valid only for the standard specifications and outputs a corresponding signal to the combinatory logic circuit 604.

If the CNF_ONFI signal is set to activate the standard specifications, the ONFI CMD decoder is deactivated by the CNF_ONFI signal while the standard CMD decoder is activated. Thus, the command sequence F1h is decoded by the standard CMD decoder, and the interpreted information is outputted to the combinatory logic circuit 604. The results may be stored in the state flip-flops 605.

If the CNF_ONFI signal is set to activate the ONFI specifications, the ONFI CMD decoder is activated by the CNF_ONFI signal while the standard CMD decoder is deactivated. Thus, the command sequence F1h is recognized as an incorrect or invalid command sequence, and the command is aborted. The results may be stored in the state flip-flops 605.

For the second and third situations where the command sequence for the two specifications differs only in part such as, for example, the sequence 60h-D1h-60h-D0h for multiplane block erase operation, the validity of the code may be determined not only based on the CNF_ONFI signal but also on the output signal of the common CMD decoder 601, thereby preventing wrong interpretation of the command sequence.

For example, the sequence 60h-D1h-60h-D0h is inputted, the common CMD decoder 601 recognizes the sequence D1h being unique to the ONFI specifications and thereby outputs the signal indicating ONFI. If the CNF_ONFI signal being inputted to the combinatory logic circuit 604, the ONFI CMD decoder 602, and/or the standard CMD decoder 603, also indicates ONFI specifications, the ONFI CMD decoder 602 and the combinatory logic circuit 604 decode and interpret the requested operation, i.e., multiplane block erase, without any problems.

However, if the CNF_ONFI signal being inputted to the combinatory logic circuit 604, the ONFI CMD decoder 602, and/or the standard CMD decoder 603 indicate standard specifications, then the combinatory logic circuit 604 ignores the serial inputs as an incorrect or invalid command. Accordingly, high reliability and accuracy in interpreting the inputted command sequences may be obtained.

The state flip-flop 605 includes an output node to which a command interpreted by the generic command interface 600 is output. As shown at node 609 in FIG. 6, the output of the state flip-flops may be feed back to the comb logic 604, and the comb logic 604 can interpret a stage of the output signal at the output node of the state flip-flops.

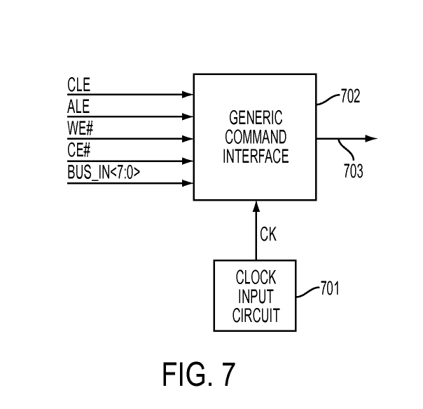

FIG. 7 shows an example of a configurable interface that can support multiple specifications, according to a third embodiment of the present disclosure.

The generic command interface 702 may have similar structural configurations as the generic command interface 600 shown in FIG. 6. The generic command interface 702 may receive clock signals CK from the clock input circuit 701. The output 703 of the generic command interface 702 may correspond to the node 609 shown in FIG. 6.

Differently from the first and second embodiments, in the third and fourth embodiment (e.g., generic command interface 702), the CNF_ONFI signal may not be used while the generic command interface 702 is still providing the functionality of recognizing a wrong command sequence, and/or confirming the validity of a command sequence. Instead, in this example, there may be a generic CMD correspondence table provided that identifies each command and its corresponding specification type.

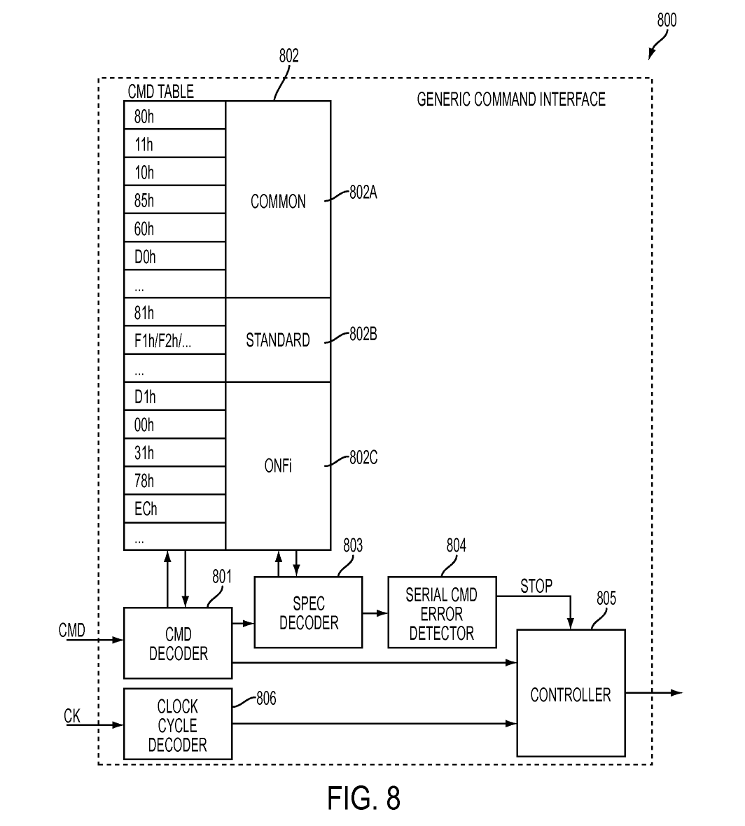

Thus, when one or more of the CMD decoders that are included in the generic command interface 702 receive the command signals (e.g., CLE, ALE, etc.), a part or all of the CMD decoders may look up the generic CMD correspondence table to find the matching command and its corresponding specification type to confirm the validity of the inputted command. An example of such an embodiment is shown in FIG. 8.

FIG. 8 shows an example of a configurable interface that can support multiple specifications, utilizing a correspondence table, which may apply to the interface 702 in FIG. 7.

According to a third embodiment of the present disclosure, there may be provided a device including a NAND flash memory, and a generic command interface. The generic command interface may include a command terminal supplying first and second command signals in serial, a first interpreter interpreting respectively the first and second command signals to detect a command to be ordered, a second interpreter detecting one of common specification, the Open NAND Flash Interface specification, and the first NAND flash specification, in response to the first and second command signals, respectively, an error detector detecting whether the detected one of the specifications by the second interpreter in response to the first command signal is identical to the detected one of the specification by the second interpreter in response to the second command signal, and a controller ignoring the interpreting of the first interpreter, when the error detector detects that the detected ones by the second interpreter are not identical to each other.

The generic command interface 800 has a CMD decoder 801, a spec decoder 803, a serial CMD error detector 804, a controller 805, and a clock cycle decoder 806. The CMD decoder 801 and spec decoder 803 may be configured to look up the pre-stored CMD correspondence table 802. The CMD correspondence table may list command sequences available in a plurality of different types of specifications and categorize each sequence as common or unique to a certain specification type. For example, the CMD correspondence table 802 lists all of the command sequences available in the standard specifications as well as in the ONFI specifications, and identifies each sequence as being common to both of the specifications (list 802A), or being unique to either the standard specifications (list 802B) or the ONFI specifications (list 802C).

When the CMD decoder 801 receive the inputted command signals (e.g., CLE, ALE, etc.), the CMD decoder 801 checks the received command signals against the CMD correspondence table 802 to determine the corresponding sequence. For example, the CMD decoder 801 decodes the received command signals as corresponding to the sequence 81h based on the CMD correspondence table 802. The decoded sequence, for example, 81h, then is transmitted to the spec decoder 803.

The spec decoder 803 then looks up the CMD correspondence table 802 again to determine the specification type of the decoded sequence. For example, if the decoded sequence was 81h, the spec decoder 803 can determine the decoded sequence 81h as being unique to the standard specifications. The output indicating “standard” may then be transmitted to the serial CMD error detector 804.

The serial CMD error detector 804 is configured to basically determine whether the output signals coming from the spec decoder 803 are consistent to each other in a series of command sequences. If the outputs are consistent for one series of the command sequences, the serial CMD error detector 804 does not enable the stop signal, and if the outputs are not consistent, the serial CMD error detector 804 enables the stop signal.

If the stop signal that is inputted to the controller 805 is enabled, the controller may stop executing the command and ignore the command as invalid. Otherwise, the controller executes the command as valid.

For example, if the command signals corresponding to the sequence 60h-D1h-60h-D0h are inputted to the generic command interface 800, then the spec decoder 803 will output to the serial CMD error detector 804 a series of signals indicating “common”-“ONFI”-“common”-“common”. Then, the serial CMD error detector 804 will recognize that there is no inconsistency in these signals and consequently will not enable the stop signal.

The controller will then execute the operation corresponding to the sequence 60h-D1h-60h-D0h, which is multiplane block erase, as indicated in Table 1 above, in accordance with the clock signals supplied by the clock cycle decoder 806.

In another example, if the command signals corresponding to the sequence 60h-D1h-60h-81h are inputted to the generic command interface 800, then the spec decoder 803 will output to the serial CMD error detector 804 a series of signals indicating “common”-“ONFI”-“common”-“standard”. Then, the serial CMD error detector 804 will recognize that there exists an inconsistency in these signals and consequently will enable the stop signal.

The controller will then annul the execution of the command as being invalid.

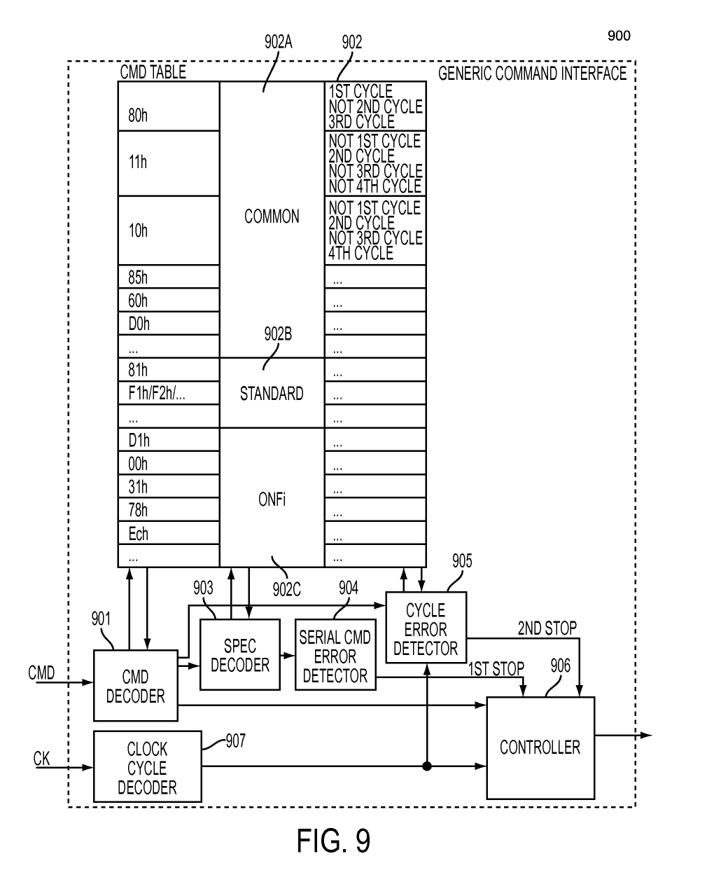

FIG. 9 shows an example of a configurable interface that can support multiple specifications, according to a fourth embodiment of the present disclosure.

The generic command interface 900 may have similar structural and/or functional configurations as the generic command interface 600 shown in FIG. 6, and/or the generic command interface 800 in FIG. 8.

According to a fourth embodiment of the present disclosure, there may be provided a device including a NAND flash memory, and a generic command interface. The generic command interface may include a cycle error detector detecting whether a cycle that the first command signal indicates is identical to a cycle that a clock cycle decoder interprets based on a clock signal, and a controller ignoring the interpreting of the first interpreter when the cycle error detector detects the cycle that the first command signal indicates is not identical to the cycle that the clock cycle decoder interprets.

In particular, in the example shown in FIG. 9, the CNF_ONFI signal may be omitted as similar to the example shown in FIG. 8 while providing an enhanced functionality to recognize wrong commands, and/or confirm validity of commands.

The generic command interface 900 has a CMD decoder 901, a spec decoder 903, a serial CMD error detector 904, a cycle error detector 905, a controller 906, and a clock cycle decoder 907. The CMD decoder 901 and spec decoder 903 may be configured to look up the pre-stored CMD correspondence table 902.

The CMD correspondence table may list command sequences available in a plurality of different types of specifications and categorize each sequence as common or unique to a certain specification type. For example, the CMD correspondence table 902 lists all of the command sequences available in the standard specifications as well as in the ONFI specifications, and identifies each sequence as being common to both of the specifications (list 902A), or being unique to either of the standard specifications (list 902B) or the ONFI specifications (list 902C).

The CMD correspondence table 902 identifies not only each of the command sequences and their corresponding specification types but also their corresponding specific cycle characteristics. For example, for the sequence 80h, the CMD correspondence table 902 indicates that the sequence is common to both the standard specifications and ONFI specifications, and also that the sequence 80h may appear in the 1^{st} cycle or 3^{rd} cycle but may not appear in the 2^{nd} cycle.

The generation of the first stop signal (i.e., 1^{st} stop outputted from the serial CMD error detector 904) may be done in a similar manner as in the example shown in FIG. 8.

However, the generic command interface 900 also generates the second stop signal (i.e., 2^{nd} stop outputted from the cycle error detector 905).

When the CMD decoder 901 receive the inputted command signals (e.g., CLE, ALE, etc.), the CMD decoder 901 checks the received command signals against the CMD correspondence table 902 to determine the corresponding sequence. For example, the CMD decoder 901 decodes the received command signals as corresponding to the sequence 11h based on the CMD correspondence table 902. The decoded sequence, for example, 11h, then is transmitted to the spec decoder 903.

Simultaneously, the CMD decoder 901 also pulls cycle information about the sequence 11h from the CMD correspondence table 902. Here, the sequence 11h may not appear in the 1^{st} or 3^{rd} cycle but may appear in the 2^{nd} or 4^{th} cycle. This information is then transmitted to the cycle error detector 905.

Alternatively, the above function of pulling the cycle information may be carried out by the spec decoder 903, if necessary or beneficial to the device.

Having received the cycle information from the CMD decoder 901 (or the spec decoder 903), the cycle error detector 905 compares the received information to the clock information inputted from the clock cycle decoder 907.

If the current clock information inputted by the clock cycle decoder 907 is one of the permitted cycles designated in the information transmitted from the CMD decoder 901, the cycle error detector 905 does not enable the 2^{nd} stop signal.

If the current clock information inputted by the clock cycle decoder 907 is one of the prohibited cycles designated in the information transmitted from the CMD decoder 901, the cycle error detector 905 enables the 2^{nd} stop signal.

If either the 1^{st} stop signal or the 2^{nd} stop signal is activated, the controller 906 annuls the interpretation of the command and stops the execution of the operation requested in the command.

If neither the 1^{st} stop signal nor the 2^{nd} stop signal is activated, the controller 906 then proceeds with interpreting the command and executing the operation requested in the command.

Accordingly, the use of both the 1^{st} and 2^{nd} stop signals can enhance the detection of invalid commands and therefore can increase the overall reliability of the device.

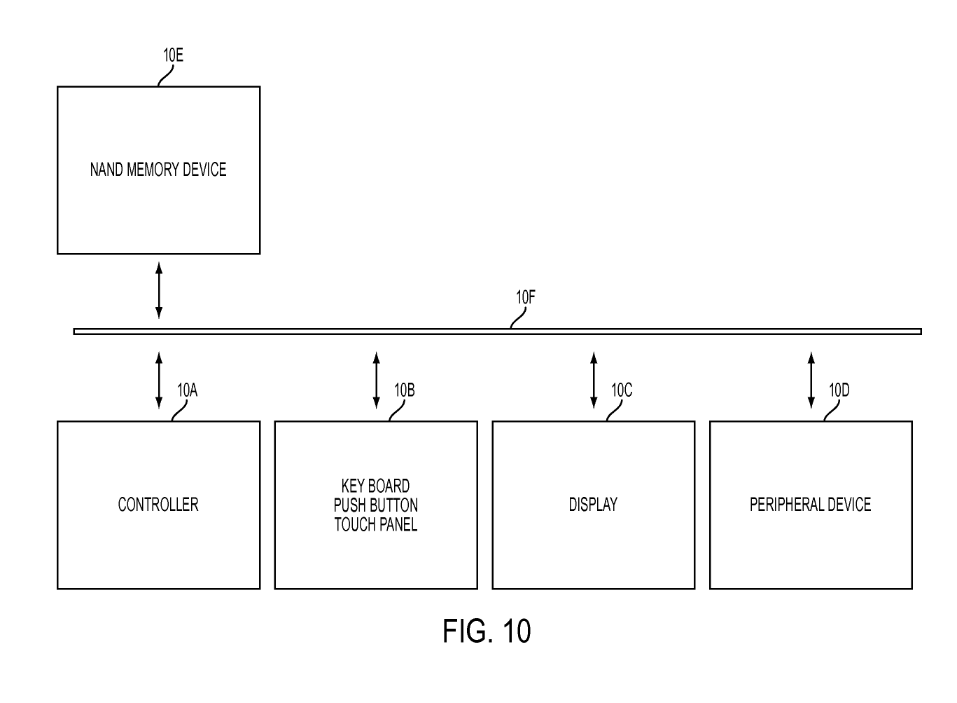

FIG. 10 shows one or more examples of a system where a NAND memory device with a configurable interface may be utilized, according to a fifth embodiment of the present disclosure.

A NAND memory device that is configured to support multiple different command specifications, including, but not limited to the standard specifications and ONFI specifications, may be utilized for various devices.

For example, as shown in FIG. 10, the NAND memory device 10E may be used to process commands generated by various different components such as the controller 10A, keyboard/push button/tough panel 10B, display 10C, and/or peripheral device 10D.

The controller 10A is configured to provide the NAND memory device 10A with command signals such as CLE, ALE, WE#, CE#, and BUS_IN<7:0>. Especially, in the above-described second embodiment, the controller 10A may be configured to provide the NAND memory device 10E with the CNF_ONFi data (signal), instead of storing the CNF_ONFi data in the NAND memory device 10E.

The keyboard/push button/tough panel 10B may be used to generate a command order for the NAND memory device 10E. The device 10B includes a component which a user inputs and orders an appropriated operation, and according to such input, an appropriate operations may be ordered by the controller 10A (i.e. command order) and be performed on the NAND memory device 10E.

The display 10C and/or peripheral device 10D may be used in accordance with this operation.

These component devices may generate commands according to the same or different specifications, but the implementation of these different components may become much easier if they are built upon the NAND devices 10E configured to support different command specifications.

In addition, the NAND memory device 10E with configurable support of multiple different command specifications may be also applicable to other devices, including, but not limited to, a personal PC, a smart phone, a server PC, a digital camera, or any similar electronic appliance with memory functionality.

The five embodiments described above may be implemented separately, or any combination of the five embodiments may be implemented together. Further, any obvious modifications to any of the specific embodiments described above to satisfy specific technical and design needs for a particular system are all considered within the scope of the claims as such will be apparent to one of ordinary skill in the art.

From the foregoing it will be appreciated that, although specific embodiments of the semiconductor device with configurable interface, or support for multiple different command specifications, have been described herein for purposes of illustration, various modifications may be made without deviating from the spirit and core principles of the disclosure.

What is claimed:

1. A device comprising:
a NAND flash memory; and
a generic command interface configured to interpret both an Open NAND Flash Interface specification and a first NAND flash specification to perform an associated one of command operations on the NAND flash memory, the Open NAND Flash Interface specification and the first NAND flash specification being different from each other.

2. The device as claimed in claim 1, wherein the generic command interface comprises:
a first command interface configured to interpret the Open NAND Flash Interface specification;
a second command interface configured to interpret the first NAND flash specification; and
a selection terminal supplying a selection signal to select one of the first and second interfaces,
the selected one of the first and second interfaces interpreting a command signal so that an non-selected one of the first and second interfaces are free from interpreting the command signal.

3. The device as claimed in claim 2, further comprising:
a controller performing an associated one of command operations on the NAND flash memory in response to the interpreting of the selected one of the first and second interfaces.

4. The device as claimed in claim 2, further comprising:
a first command terminal coupled to the first command interface; and
a second command terminal coupled to the second command interface.

5. The device as claimed in claim 4, wherein the first and second command terminal are identical to each other.

6. The device as claimed in claim 4, wherein the first and second command terminal are different from each other.

7. The device as claimed in claim 2, wherein a state of the selection signal is determined after the device has been manufactured.

8. The device as claimed in claim 1, wherein the generic command interface comprises:
a first terminal supplied with a first signal;
a first interpreter coupled to the first terminal and configured to interpret the Open NAND Flash Interface specification in response to the first signal supplied from the first terminal;
a second interpreter coupled to the first terminal and configured to interpret the first NAND Flash specification in response to the first signal supplied from the first terminal;
a third interpreter coupled to the first terminal and configured to detect one of the Open NAND Flash Interface specification and the first NAND flash specification that the first signal supplied at the first terminal belongs to; and
a selection terminal supplying a selection signal to select one of the first and second command decoders.

9. The device as claimed in claim 8, further comprising:
a controller ignoring an interpretation of the selected one of the first and second interpreters, when a specification to be interpreted by the selected one of the first and second interpreters is different from the detected one, by the third interpreter, of the Open NAND Flash Interface specification and the first NAND flash specification.

10. The device as claimed in claim 1, wherein the generic command interface comprises:
a clock terminal supplying a clock signal to the generic command interface so that the clock signal is used for the generate command interfaces to interpret.

11. The device as claimed in claim 1, wherein the generic command interface comprises:
a command terminal supplying first and second command signals in serial;
a first interpreter interpreting respectively the first and second command signals to detect a command to be ordered;
a second interpreter detecting one of common specification, the Open NAND Flash Interface specification, and the first NAND flash specification, in response to the first and second command signals, respectively;
an error detector detecting whether the detected one of the specifications by the second interpreter in response to the first command signal is identical to the detected one of the specification by the second interpreter in response to the second command signal; and
a controller ignoring the interpreting of the first interpreter, when the error detector detects that the detected ones by the second interpreter are not identical to each other.

12. The device claimed in claim 11, wherein the second interpreter looks up a command correspondence table that stores information indicating whether a command sequence is common to the Open NAND Flash Interface and first NAND flash specifications, or being unique to either the Open NAND Flash Interface specification or the first NAND flash specification.

13. The device as claimed in claim 11, wherein the generic command interface comprising:
a cycle error detector detecting whether a cycle that the first command signal indicates is identical to a cycle that a clock cycle decoder interprets based on a clock signal; and
a controller ignoring the interpreting of the first interpreter when the cycle error detector detects the cycle that the first command signal indicates is not identical to the cycle that the clock cycle decoder interprets.

14. The device as claimed in claim 13, wherein the controller ignores the command as being invalid if either one of the cycle error detector or the error detector detects an error.

15. The device as claimed in claim 13, wherein the second decoder looks up a command correspondence table that stores information indicating whether a command sequence is common to the Open NAND Flash Interface and first NAND Flash specifications, or being unique to either one of the Open NAND Flash Interface specification or the first NAND flash specification, and also information indicating which cycles are permitted for a command sequence.

16. The device as claimed in claim 1, wherein the first NAND flash specification is a specification defined by a device manufacturer that is different from manufactures that belongs to Open NAND Flash interface work group.

17. The device as claimed in claim 1, wherein the first NAND flash specification comprises at least one of USB (Universal Serial Bus) drive specification, SD (Security Digital) card specification, Solid State Drives specification, e-MMC (Embedded Multi Media Card) specification, and Universal Flash Storage (UFS) specification defined by JEDEC.

18. A method comprising:
providing a device comprising a command terminal and a command interface that supports multiple command specifications including an Open NAND Flash Interface specification and a first specification that is different from the Open NAND Flash Interface specification;
receiving a command signal from the command terminal of the device;
selecting one of the multiple command specifications to be interpreted; and
interpreting the command signal in response to the receiving of the command signal and the selecting of the one of the multiple command specifications so that a remaining of the multiple command specifications is free from being interpreted.

19. The method claimed in claim 18, further comprising:
manufacturing the device; and
wherein, the selecting one of the multiple command specifications is done after manufacturing the device, so that a specification to be used by the device is set up after manufacturing the device.

20. The method claimed in claim 18, wherein the first specification is a specification defined by a device manufacturer that is different from manufactures that belong to Open NAND Flash interface work group defining the Open NAND Flash Interface specification.
